(19) United States
(12) Patent Application Publication
(10) Pub. No.: US 2024/0137767 A1
(43) Pub. Date: Apr. 25, 2024

(54) MESSAGE RETRANSMISSION MISBEHAVIOR DETECTION

(71) Applicant: QUALCOMM Incorporated, San Diego, CA (US)

(72) Inventors: Jonathan PETIT, Wenham, MA (US); Abhijit NAVALEKAR, Westford, MA (US); Mohammad NEKOUI, San Diego, CA (US)

(21) Appl. No.: 18/049,400

(22) Filed: Oct. 24, 2022

(51) Int. Cl. H04W 12/106; H04W 12/122

(52) U.S. Cl. CPC H04W 12/106; H04W 12/122

(57) ABSTRACT

Various embodiments include methods and systems for performing misbehavior detection in a message retransmission. In various embodiments, a computing device may compare a first aspect of a first message to a second aspect of a second message that purports to be a retransmission of the first message, identify retransmission misbehavior in the second message based on the comparison, and take an action in response to identifying retransmission misbehavior in the second message.

### BACKGROUND

Message retransmissions of wireless communication packets enables accurate communication of information in environments in which such wireless signals may be lost, corrupted, or incompletely received. In some implementations, a transmitting device may send information packets two, three, or more times to enable a receiving device to receive the information. Even if portions of the information are lost in transmission, receiving multiple copies of the information may enable the receiving device to reassemble or otherwise recover the transmitted information.

However, retransmissions of wireless message packets could be subject to attack. For example, a malicious actor could transmit a message that purports to be a retransmission of information by another device, but is in fact is different from the original message. In this manner, the attacker attempts to introduce conflicting information into a communication system, which may hinder or disrupt operations of the communication system. In some cases, such as intelligent traffic systems or communication systems of autonomous or semi-autonomous vehicles, spreading misinformation among receiving devices could pose a threat to human safety.

### SUMMARY

Various aspects include methods that may be performed by a computing device for misbehavior detection in a message retransmission. In some aspects, a computing device may compare a first aspect of a first message to a second aspect of a second message that purports to be a retransmission of the first message, may identify retransmission misbehavior in the second message based on the comparison, and may take an action in response to identifying retransmission misbehavior in the second message.

In some aspects, comparing the first aspect of the first message and the second aspect of the second message may include comparing first computing resources consumed by the first message and second 2 computing resources consumed by the second message. Some aspects may include comparing first message content of the first message to second message content of the second message in response to determining that the computing resources consumed by the first message and the computing resources consumed by the second message are the same. In such aspects, identifying retransmission misbehavior in the second message based on the comparison may include identifying retransmission misbehavior in the second message in response to determining that the first message content of the first message and the second message content of the second message are not the same.

In some aspects, comparing the first aspect of the first message and the second aspect of the second message may include comparing one or more first decode metrics of the first message to one or more second decode metrics of the second metric. In some aspects, comparing the first aspect of the first message to the second aspect of the second message may include comparing one or more first Layer 1 or Layer 2 decode metrics of the first message to one or more second Layer 1 or Layer 2 decode metrics of the second metric. In some aspects, comparing the first aspect of the first message and the second aspect of the second message may include comparing a first combination of the first message and a third message that purports to be a retransmission of the first message, to a second combination of the second message and the third message.

In some aspects, comparing the first aspect of the first message and the second aspect of the second message may include comparing one or more first decode metrics of the first message to one or more second decode metrics of the second message, and selecting the first message or the second message to combine with a third message that purports to be a retransmission of the first message based on the comparison of the one or more first decode metrics of the first message to the one or more second decode metrics of the second message. In such aspects, identifying retransmission misbehavior in the second message based on the comparison may include identifying retransmission behavior in the first message or the second message that was not selected based on the comparison of the one or more first decode metrics of the first message to the one or more second decode metrics of the second message. In some aspects, the computing device may include a vehicle-to-everything (V2X) processing system.

Further aspects include a computing device including a memory and a processor configured to perform operations of any of the methods summarized above. Further aspects may include a computing device having various means for performing functions corresponding to any of the methods summarized above. Further aspects may include a non-transitory processor-readable storage medium having stored thereon processor-executable instructions configured to cause a processor of a computing device to perform various operations corresponding to any of the methods summarized above.

### BRIEF DESCRIPTION OF THE DRAWINGS

The accompanying drawings, which are incorporated herein and constitute part of this specification, illustrate exemplary embodiments of the claims, and together with the general description given and the detailed description, serve to explain the features herein.

FIG. 1A is a system block diagram illustrating an example communication system suitable for implementing various embodiments.

FIG. 1B is a system block diagram illustrating an example disaggregated base station architecture suitable for implementing various embodiments.

FIG. 1C is a system block diagram illustrating a communication system suitable for implementing various embodiments.

FIG. 2 is a component diagram of an example vehicle V2X processing system suitable for implementing various embodiments.

FIG. 3A is a block diagram illustrating components of a system on chip for use in a vehicle V2X processing system in accordance with various embodiments.

FIG. 3B is a component block diagram illustrating elements of a vehicle V2X processing system configured in accordance with various embodiments.

FIGS. 4A and 4B are conceptual diagrams of example retransmission attacks in message retransmission scenarios.

FIG. 5A is a process flow diagram of an example method performed by a processor of computing device for misbehavior detection in a message retransmission.

FIGS. 5B-5E are process flow diagrams of example operations and that may be performed by a processor of computing device as part of the method for misbehavior detection in a message retransmission.

FIG. 6 is a component block diagram of a computing device suitable for use with various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

Various embodiments include methods, and computing devices implementing the methods, for detecting misbehavior in a message that purports to be a retransmission of an earlier message (“retransmission misbehavior”). In various embodiments, a computing device may include one or more processors and/or other components configured to perform operations for detecting retransmission misbehavior. In various embodiments, a computing device may compare a first aspect of a first message to a second aspect of a second message that purports to be a retransmission of the first message. Based on this comparison, the computing device may identify misbehavior in a second message that purports, incorrectly, to be a retransmission of the first message. In response to identifying retransmission misbehavior in the second message, the computing device may take an action, such as send a misbehavior report. In some embodiments, the computing device may be implemented in a vehicle-to-everything (V2X) processing system of a vehicle. In some embodiments, the computing device may be implemented in a network element of a V2X system, such as a roadside unit (RSU), an Edge computing device, or another suitable network element.

As used herein, the term “vehicle” refers generally to any of an automobile, motorcycle, truck, bus, train, boat, and any other type of vehicle V2X-capable system that may be configured to manage transmission of misbehavior reports.

The term “system on chip” (SOC) is used herein to refer to a single integrated circuit (IC) chip that contains multiple resources and/or processors integrated on a single substrate. A single SOC may contain circuitry for digital, analog, mixed-signal, and radio-frequency functions. A single SOC may also include any number of general purpose and/or specialized processors (digital signal processors, modem processors, video processors, etc.), memory blocks (e.g., ROM, RAM, Flash, etc.), and resources (e.g., timers, voltage regulators, oscillators, etc.). SOCs may also include software for controlling the integrated resources and processors, as well as for controlling peripheral devices.

The term “system in a package” (SIP) may be used herein to refer to a single module or package that contains multiple resources, computational units, cores and/or processors on two or more IC chips, substrates, or SOCs. For example, a SIP may include a single substrate on which multiple IC chips or semiconductor dies are stacked in a vertical configuration. Similarly, the SIP may include one or more multi-chip modules on which multiple ICs or semiconductor dies are packaged into a unifying substrate. A SIP may also include multiple independent SOCs coupled together via high speed communication circuitry and packaged in close proximity, such as on a single motherboard or in a single wireless device. The proximity of the SOCs facilitates high speed communications and the sharing of memory and resources.

Message retransmission in wireless communication systems enables accurate communication of information in environments in which the wireless signals conveying the information may be lost, corrupted, or incompletely received. Various communication systems may implement a variety of retransmission mechanisms. For example, the Hybrid Automatic Repeat Request (HARQ) has been widely implemented in variety of communication systems. HARQ may include a combination of forward error correction (FEC) codes along with operations to perform Automatic Repeat Request (ARQ) error-control and soft-combining.

In message retransmission operations, a transmitting device may transmit two copies of a data unit (such as a packet) within a determined packet delay budget time frame. In such operations, the transmitting device may send each packet with different coding. A receiving device may receive the initial message and the retransmitted message, and use both messages to determine the information sent by the transmitting device. In some implementations, if the receiving device is not able to decode the initial message, the receiving device may store the initial message (e.g., in a buffer memory) and monitor for the second message, which in some implementations may arrive within a specified time following the first message, e.g., within 15 milliseconds. The receiving device may combine the initial message and the retransmitted message and attempt to decode the combined message. If the receiving device is able to decode the initial message, the receiving device need not monitor for the retransmitted message.

Retransmission mechanisms may be subject to a variety of attacks. In a first type of attack, an attacker may attempt to send messages that cause receiving devices to receive different or conflicting information, e.g., describing the same environment or a shared environment. Such an attack may be particularly pernicious in a V2X system. For example, an attacker may transmit an initial message (msg1) that includes one set of information, and then transmit a purported retransmission (msg1′) that includes another set information differing from the information in the initial message. This second message transmitted by an attacker is sometimes referred to herein as an “attack message.” A first receiving device that properly receives the initial message msg1 may ignore the purported retransmission (attack message) msg1′, and thus not be informed about the conflicting information in the attack message. However, a second receiving device that did not decode the initial message msg1 will monitor for the retransmission message, and could then receive the attack message msg1′. If this happens, the first receiving device and the second receiving device will have received different information in messages purporting to have the same content. To make matters worse, in some systems, such as Incremental Redundancy (IR) HARQ, the attacker may transmit the purported retransmission (attack message) msg1′ at a high enough signal strength such that the second receiving device may fully decode the purported retransmission msg1′ without reference to a stored version of the initial message msg1, which may have been partially decoded (i.e., the stored version of msg1 is partial, incomplete, are garbled).

In a second type of attack, an attacker may receive an initial message msg1 from a transmitting device, and then transmit a purported retransmission (attack message) msg1′ including different or conflicting information. The attacker may transmit the attack message at a higher transmit power than a legitimate retransmission by the legitimate transmitting device. Receiving devices that properly receive the initial message msg1 may ignore the purported retransmission msg1′. However, receiving devices that monitor for a retransmission may receive and decode the attack message msg1′ instead of the legitimate retransmission. In some attacks, the attack message msg1′ may be encoded with the same or different decode parameters, such as a different redundancy version (RV), modulation and coding scheme (MCS), and/or the like. In some embodiments, depending on specific Transport Block parameters, such as packet size, code rate, or MCS, a HARQ retransmission (e.g., the attack message msg1′) may be decodable without reference to another message (such as the initial message msg1).

In the context of V2X communications, a retransmission attack of either type may cause a first receiving vehicle and a second receiving vehicle to have different information regarding another vehicle's (e.g., the transmitting vehicle's) location, behavior, movements, kinematic state, proposed or intended maneuvers, and the like. Given that V2X communications convey information between vehicles and an intelligent highway system to enable safer operations, an attacker injecting conflicting messages in this manner could impact highway and vehicle safety. Therefore, methods for detecting retransmission attacks and retransmission misbehavior may provide safety advantages.

Various embodiments include methods, and computing devices implementing the methods, for detecting retransmission misbehavior in wireless communications. In some embodiments, a computing device may compare a first aspect of a first message to a second aspect of a second message that purports to be a retransmission of the first message, identify retransmission misbehavior in the second message based on the comparison, and take an action in response to identifying retransmission misbehavior in the second message. As used herein, the terms “first message” and “second message” each include a complete message, a partial message, a portion of a message, an incomplete message, a damaged message, a corrupted message, and other suitable messages according to various embodiments. In some embodiments, the computing device may receive the first message and the second message that purports to be a retransmission of the first message, and may perform one or more operations to determine whether first message and the second message are consistent.

In some embodiments, the computing device may compare first computing resources consumed by the first message to second computing resources consumed by the second message. For example, a receiving device may determine processing resources consumed, memory resources consumed, an amount of time consumed, and other suitable resources that may be consumed receiving and/or attempting to decode a first message and/or second message. In some embodiments, in response to determining that different computing resources are consumed by receiving and decoding the first message and the second message, the computing device may identify retransmission misbehavior in the second message.

In some embodiments, in response to determining that similar or the same computing resources are consumed by receiving and decoding the first message and the second message, the computing device may compare first message content of the first message to second message content of the second message. In response to determining that the first message content and the second message content are not the same, the computing device may identify retransmission misbehavior in the second message. In various embodiments, in response to identifying retransmission misbehavior in the second message, the computing device may take an action, such as ignoring the information, treating either or both of the messages as suspect, reporting misbehavior in the messages to others, and the like. For example, the computing device may generate a misbehavior report detailing the detected retransmission misbehavior and transmit the misbehavior report to a Misbehavior Authority and/or other network entity. In some embodiments, the computing device may include examples of identified misbehavior with or in the misbehavior report as evidence of the identified misbehavior.

In some embodiments, the computing device may compare a first digital signature associated with the first message to a second digital signature associated with the second message. It some embodiments, a security layer of the computing device may compare the digital signatures. In the event of a retransmission attack, the computing device may determine that the digital signature associated with the first message is different than the second digital signature associated with the second message. In some embodiments, the computing device may identify retransmission misbehavior in the second message in response to determining that the digital signatures are different.

In some embodiments, the computing device may compare one or more first decode metrics of the first message to one or more second decode metrics of the second message. Comparing decode metrics of the first and second messages may be used to recognize retransmission behavior when either the first or second messages are not fully decoded. For example, a transmitting device may transmit a first message, but a receiving device may be unable to decode the first message. In response to a retransmission request, the transmitting device may retransmit the first message, but an attacker may interfere with (e.g., jam) the channel, for example by transmitting an attack message in the transmitting device's subframes. The receiving device may receive the attack message, and may be unable to decode the attack message, or to combine the first message and the attack message, to properly decode the first message.

In some embodiments, the computing device may compare decode metrics to determine an inconsistency in decode metrics (or decode parameters) between the first message and the second message. In some embodiments, decode metrics (or decode parameters) may include signal characteristics determined by a computing device when decoding a message. Examples of decode metrics include a demodulation reference signal (DMRS), a signal-to-noise ratio (SNR), a symbol error rate (SER), a determined signal quality (e.g., a channel Log Likelihood Ratio (LLR) magnitude), a carrier frequency offset (CFO), and/or a symbol timing offset (STO). Another example of a decode metric includes scheduling parameters, such as whether a first message or a second message is received at a time when it is expected (e.g., scheduled), at a time when it is not expected (e.g., not scheduled), in an indicated or scheduled time slot, in a time slot other than an indicated or scheduled time slot, and/or the like. In some embodiments, the decode metrics compared by the computing device may include layer 1 decode metrics. In some embodiments, the decode metrics compared by the computing device may include Layer 1 and/or Layer 2 2 decode metrics or decode parameters. The terms “Layer 1” and “Layer 2” refer to the physical layer and the data link layer, respectively, of the Open Systems Interconnection (OSI) model. In some embodiments, the computing device may perform operations to compare decode metrics at Layer 2 of a protocol stack the computing device, to save processing resources of the computing device that may be consumed by passing the first message and/or the second message to higher layers of a protocol stack. In some embodiments, the computing device may identify retransmission misbehavior in the second message in response to determining that one or more of the first decode metrics in one or more of the second decode metrics are different. In some embodiments, differences in decode metrics may be included in a misbehavior report as evidence of the detected misbehavior.

In some embodiments, the computing device may compare a first combination of the first message and a third message that purports to be a retransmission of the first message, and a second combination of the second message and the third message. In some embodiments, the computing device may identify retransmission in the second message based on the comparison of the two combinations. In some embodiments, the computing device may compare verification information of each of the two combinations, such as a cyclic redundancy check (CRC). For example, if the second message is an attack message, a CRC of the second combination may fail a verification check, while a CRC of the first combination may pass.

In conventional retransmission mechanisms (such as in a decode cycle implemented in a modem of the receiver device), a receiver device may combine initial messages and purported retransmissions, and store only the combined message. To mitigate information corruption that may arise from such implementations, in various embodiments, the receiving device may store the first message and the second message separately and not combine the first message and the second message.

In some embodiments, rather than combining the first message with third message, and separately the second message with the third message, the receiving device may select one of the first message and the second message to combined with the third message. In some embodiments, the computing device may compare one or more first decode metrics of the first message and one or more second decode metrics of the second message, and may select the first message or the second message based on the comparison of the decode metric(s) of the first message and the second message. For example, based on decode metrics such as CFO, SER, and/or a timing between the transmission of the first message and the second message, the computing device may determine that one of the first message and the second message is more likely to be legitimate and/or that one of the first message of the second message more likely to be an attack message. In such embodiments, the computing device may select either the first message or the second message that is more likely to be legitimate and/or less likely to be attack message. The computing device may combine the selected message with the third message and attempt to decode the combined message.

Various embodiments improve the safety and efficiency of processing systems and communication systems by enabling computing devices to identify and take appropriate action in response to detected retransmission misbehavior. Race embodiments improve the safety and operation of systems in which such computing devices are deployed by enabling computing devices to reduce or eliminate disruptions to communications, including disinformation or misinformation, that an attacker attempts to inject into a retransmission process.

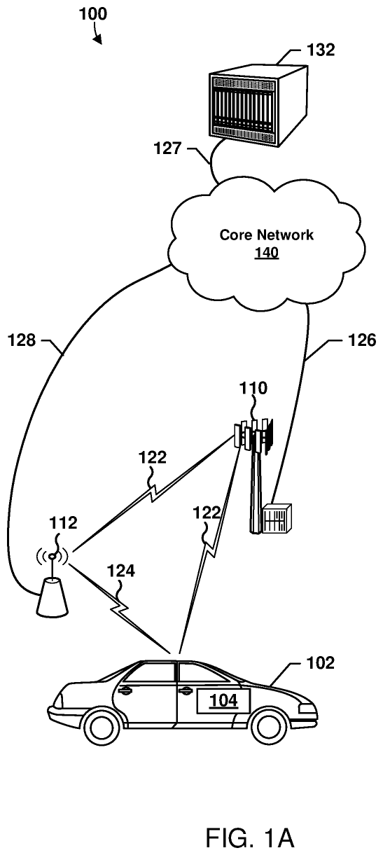

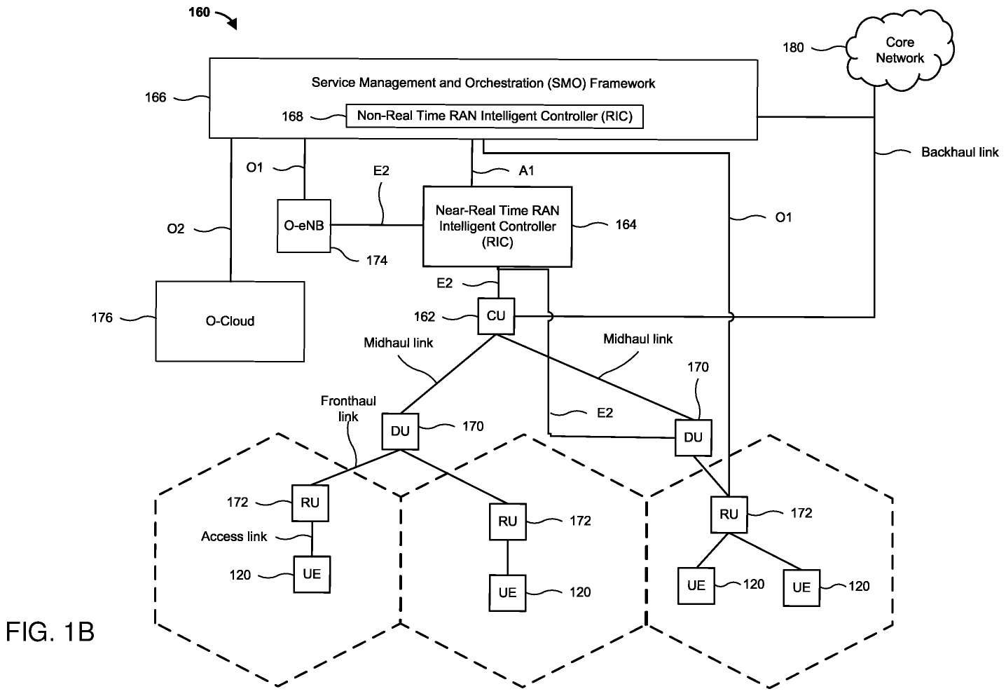

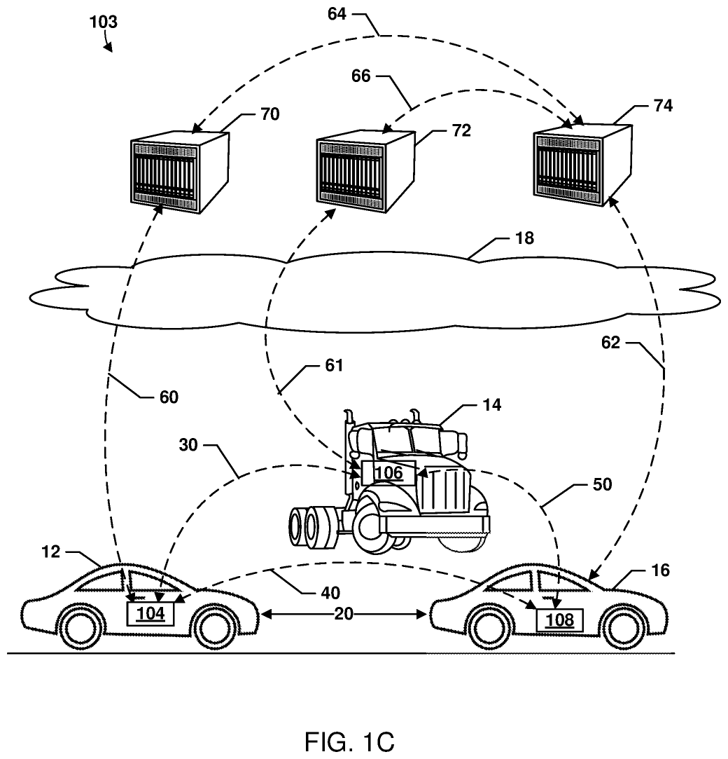

FIG. 1A is a system block diagram illustrating an example communication system 100 suitable for implementing the various embodiments. The communications system 100 include a 5G New Radio (NR) network, an intelligent transportation system (ITS) V2X wireless network, and/or any other suitable network such as a Long Term Evolution (LTE) network. References to a 5G network and 5G network elements in the following descriptions are for illustrative purposes and are not intended to be limiting.

The communications system 100 may include a heterogeneous network architecture that includes a core network 140, a number of base stations 110, and a variety of mobile devices including a vehicle 102 equipped with a V2X processing system 104 that includes wireless communication capabilities. The base station 110 may communicate with a core network 140 over a wired communication link 126. The communications system 100 also may include roadside units 112 supporting V2X communications with vehicles 102 via V2X wireless communication links 124.

A base station 110 is a network element that communicates with wireless devices (e.g., a V2X processing system 104 of the vehicle 102) via a wireless communication link 122, and may be referred to as a Node B, an LTE Evolved nodeB (eNodeB or eNB), an access point (AP), a radio head, a transmit receive point (TRP), a New Radio base station (NR BS), a 5G NodeB (NB), a Next Generation NodeB (gNodeB or gNB), or the like. Each base station 110 may provide communication coverage for a particular geographic area or “cell.” In 3GPP, the term “cell” can refers to a coverage area of a base station, a base station subsystem serving this coverage area, or a combination thereof, depending on the context in which the term is used. The core network 140 may be any type of core network, such as an LTE core network (e.g., an evolved packet core (EPC) network), 5G core network, a disaggregated network as described with reference to FIG. 1B, etc.

Roadside units 112 may communicate with the core network 140 via a wired or wireless communication link 128. Roadside units 112 may communicate via V2X wireless communication links 124 with V2X processing system-equipped vehicles 102 for downloading information useful for V2X processing system autonomous and semi-autonomous driving functions, and for receiving information such as misbehavior reports from the V2X processing system 104.

A Misbehavior Authority network computing device (MA) 132 may communicate with the core network 140 via a wired or wireless communication link 127. The MA 132 may receive misbehavior reports from the V2X processing system 104 as may be sent by the V2X processing system 104 from time to time.

Wireless communication links 122 may include a plurality of carrier signals, frequencies, or frequency bands, each of which may include a plurality of logical channels. The wireless communication links 122 and 124 may utilize one or more radio access technologies (RATs). Examples of RATs that may be used in a wireless communication link include 3GPP LTE, 3G, 4G, 5G (e.g., NR), GSM, Code Division Multiple Access (CDMA), Wideband Code Division Multiple Access (WCDMA), Worldwide Interoperability for Microwave Access (WiMAX), Time Division Multiple Access (TDMA), and other mobile telephony communication technologies cellular RATs. Further examples of RATs that may be used in one or more of the various wireless communication links within the communication system 100 include medium range protocols such as Wi-Fi, LTE-U, LTE-Direct, LAA, MuLTEfire, and relatively short range RATs such as ZigBee, Bluetooth, and Bluetooth Low Energy (LE).

FIG. 1B is a system block diagram illustrating an example disaggregated base station 160 architecture that may be part of a V2X and/or 5G network (e.g., the communication system 100) according to any of the various embodiments. With reference to FIGS. 1A and 1B, the disaggregated base station 160 architecture may include one or more central units (CUs) 162 that can communicate directly with a core network 180 via a backhaul link, or indirectly with the core network 180 through one or more disaggregated base station units, such as a Near-Real Time (Near-RT) RAN Intelligent Controller (RIC) 164 via an E2 link, or a Non-Real Time (Non-RT) RIC 168 associated with a Service Management and Orchestration (SMO) Framework 166, or both. A CU 162 may communicate with one or more distributed units (DUs) 170 via respective midhaul links, such as an F1 interface. The DUs 170 may communicate with one or more radio units (RUs) 172 via respective fronthaul links. The RUs 172 may communicate with respective UEs 120 via one or more radio frequency (RF) access links. In some implementations, user equipment (UE), such as a V2X processing system 104, may be simultaneously served by multiple RUs 172.

Each of the units (i.e., CUs 162, DUs 170, RUs 172), as well as the Near-RT RICs 164, the Non-RT RICs 168 and the SMO Framework 166, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 162 may host one or more higher layer control functions. Such control functions may include the radio resource control (RRC), packet data convergence protocol (PDCP), service data adaptation protocol (SDAP), or the like. Each control function may be implemented with an interface configured to communicate signals with other control functions hosted by the CU 162. The CU 162 may be configured to handle user plane functionality (i.e., Central Unit-User Plane (CU-UP)), control plane functionality (i.e., Central Unit-Control Plane (CU-CP)), or a combination thereof. In some implementations, the CU 162 can be logically split into one or more CU-UP units and one or more CU-CP units. The CU-UP unit can communicate bidirectionally with the CU-CP unit via an interface, such as the E1 interface when implemented in an O-RAN configuration. The CU 162 can be implemented to communicate with DUs 170, as necessary, for network control and signaling.

The DU 170 may correspond to a logical unit that includes one or more base station functions to control the operation of one or more RUs 172. In some aspects, the DU 170 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 170 may further host one or more low PHY layers. Each layer (or module) may be implemented with an interface configured to communicate signals with other layers (and modules) hosted by the DU 170, or with the control functions hosted by the CU 162.

Lower-layer functionality may be implemented by one or more RUs 172. In some deployments, an RU 172, controlled by a DU 170, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 172 may be implemented to handle over the air (OTA) communication with one or more UEs 120. In some implementations, real-time and non-real-time aspects of control and user plane communication with the RU(s) 172 may be controlled by the corresponding DU 170. In some scenarios, this configuration may enable the DU(s) 170 and the CU 162 to be implemented in a cloud-based radio access network (RAN) architecture, such as a vRAN architecture.

The SMO Framework 166 may be configured to support RAN deployment and provisioning of non-virtualized and virtualized network elements. For non-virtualized network elements, the SMO Framework 166 may be configured to support the deployment of dedicated physical resources for RAN coverage requirements, which may be managed via an operations and maintenance interface (such as an O1 interface). For virtualized network elements, the SMO Framework 166 may be configured to interact with a cloud computing platform (such as an open cloud (O-Cloud) 176) to perform network element life cycle management (such as to instantiate virtualized network elements) via a cloud computing platform interface (such as an O2 interface). Such virtualized network elements can include, but are not limited to, CUs 162, DUs 170, RUs 172 and Near-RT RICs 164. In some implementations, the SMO Framework 166 may communicate with a hardware aspect of a 4G RAN, such as an open eNB (O-eNB) 174, via an O1 interface. Additionally, in some implementations, the SMO Framework 166 may communicate directly with one or more RUs 172 via an O1 interface. The SMO Framework 166 also may include a Non-RT RIC 168 configured to support functionality of the SMO Framework 166.

The Non-RT RIC 168 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 164. The Non-RT RIC 168 may be coupled to or communicate with (such as via an A1 interface) the Near-RT RIC 164. The Near-RT RIC 164 may be configured to include a logical function that enables near-real-time control and optimization of RAN elements and resources via data collection and actions over an interface (such as via an E2 interface) connecting one or more CUs 162, one or more DUs 170, or both, as well as an O-eNB, with the Near-RT RIC 164.

In some implementations, to generate AI/ML models to be deployed in the Near-RT RIC 164, the Non-RT RIC 168 may receive parameters or external enrichment information from external servers. Such information may be utilized by the Near-RT RIC 164 and may be received at the SMO Framework 166 or the Non-RT RIC 168 from non-network data sources or from network functions. In some examples, the Non-RT RIC 168 or the Near-RT RIC 164 may be configured to tune RAN behavior or performance. For example, the Non-RT RIC 168 may monitor long-term trends and patterns for performance and employ AI/ML models to perform corrective actions through the SMO Framework 166 (such as reconfiguration via O1) or via creation of RAN management policies (such as A1 policies).

FIG. 1C is a system block diagram illustrating a communication system 103 suitable for implementing various embodiments. With reference to FIGS. 1A-1C, the communication system 103 may include three vehicles 12, 14, 16. Each vehicle 12, 14, 16 may include a V2X processing system 104, 106, 108, respectively, each configured to periodically broadcast V2X messages 30, 40, 50 such as BSM, CAM, MCM, MAP, SRM, and other types of V2X messages for receipt and processing by other vehicles' V2X processing systems (e.g., 104, 106, 108).

By sharing the vehicle location, speed, direction, braking, and other information, vehicles can maintain safe separation and identify and avoid potential collisions. For example, a trailing vehicle 12 receiving V2X messages 40 from a leading vehicle 16 can determine the speed and location of the vehicle 16, which in turn enables vehicle 12 to match the speed and maintain a safe separation distance 20.

By being informed through V2X messages 40 when the leading vehicles 16 applies the brakes, the V2X processing system 102 in the trailing vehicle 12 can apply brakes simultaneously to maintain the safe separation distance 20 even when the leading vehicle 16 stops suddenly. As another example, the V2X processing system 104 within the truck vehicle 14 may receive V2X messages 30, 50 from the two vehicles 12, 16, and thus be informed that the truck vehicle 14 should stop at the intersection to avoid a collision.

Each of the vehicle V2X on-board equipment 104, 106, 108 may communicate with one another using any of a variety close proximity communication protocols. In addition, the vehicles may be able to transmit data and information regarding detected V2X messages as well as a misbehavior report about detected V2X misbehavior to an original equipment manufacturer (OEM) (70, 72) and/or MA 74 (e.g., 132) via communication links 60, 61, 62 through a communication network 18. The misbehavior report may be transmitted directly to the MA 74 (e.g., via communication link 64, 66).

In some embodiments, the misbehavior report may first be transmitted to a misbehavior report pre-processing unit such as the OEM servers 70, 72 for pre-processing through communication links 64, 66. Then the pre-processed misbehavior report may be transmitted from the misbehavior report pre-processing servers 70, 72 to the MA 74 through communication links 64, 66.

In some embodiments, a misbehavior report may be received from a vehicle, such as from vehicle 16, at the MA 74. The MA 74 may relay the received misbehavior report from the vehicle 16 onto OEM servers 70, 72 via communication links 64, 66. In addition, the OEM servers 70, 72 may provide confirmation reports to the MA 74 via communication links 64, 66.

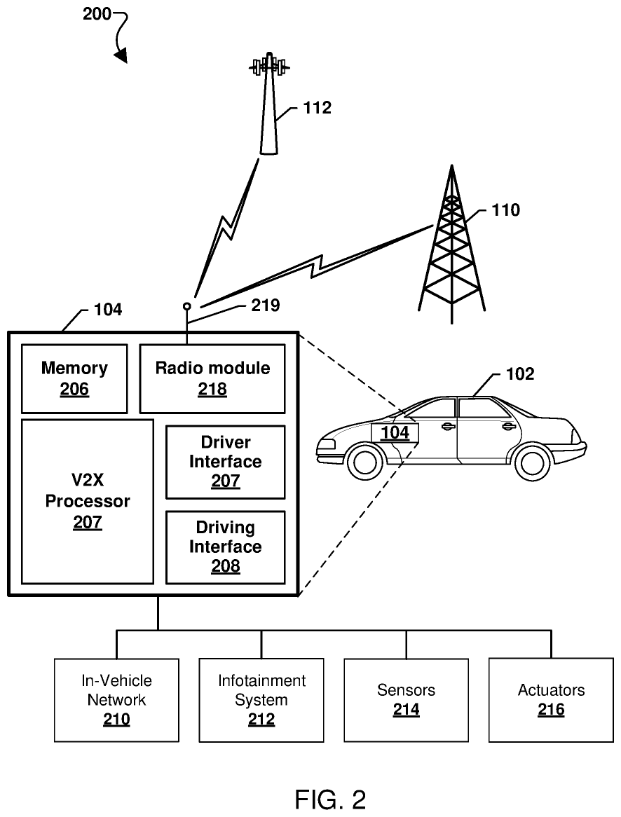

FIG. 2 is a component diagram of an example vehicle V2X processing system 200 suitable for implementing various embodiments. With reference to FIGS. 1A-2, the processing system 200 may include a vehicle 102 that includes a V2X processing system 104. The vehicle V2X processing system 104 may communicate with various systems and devices, such as an in-vehicle network 210, an infotainment system 212, various sensors 214, various actuators 216, and a radio module 218 coupled to an antenna 219. The vehicle V2X processing system 104 also may communicate with roadside units 112, cellular communication network base stations 110, and other external devices.

The V2X processing system 104 may include a processor 205, memory 206, an input module 207, an output module 208 and the radio module 218. The processor 205 may be coupled to the memory 206 (i.e., a non-transitory storage medium), and may be configured with processor-executable instructions stored in the memory 206 to perform operations of the methods according to various embodiments described herein. Also, the processor 205 may be coupled to the output module 208, which may control in-vehicle displays, and to the input module 207 to receive information from vehicle sensors as well as driver inputs.

The V2X processing system 104 may include a V2X antenna 219 coupled to the radio module 218 that is configured to communicate with one or more ITS participants (e.g., stations), a roadside unit 112, and a base station 110 or another suitable network access point. The V2X antenna 219 and radio module 218 may be configured to receive dynamic traffic flow feature information via vehicle-to-everything (V2X) communications. In various embodiments, the V2X processing system may receive information from a plurality of information sources, such as the in-vehicle network 210, infotainment system 212, various sensors 214, various actuators 216, and the radio module 218. The V2X processing system may be configured to perform autonomous or semi-autonomous driving functions using map data in addition to sensor data, as further described below.

Examples of an in-vehicle network 210 include a Controller Area Network (CAN), a Local Interconnect Network (LIN), a network using the FlexRay protocol, a Media Oriented Systems Transport (MOST) network, and an Automotive Ethernet network. Examples of vehicle sensors 214 include a location determining system (such as a Global Navigation Satellite Systems (GNSS) system, a camera, radar, lidar, ultrasonic sensors, infrared sensors, and other suitable sensor devices and systems. Examples of vehicle actuators 216 include various physical control systems such as for steering, brakes, engine operation, lights, directional signals, and the like.

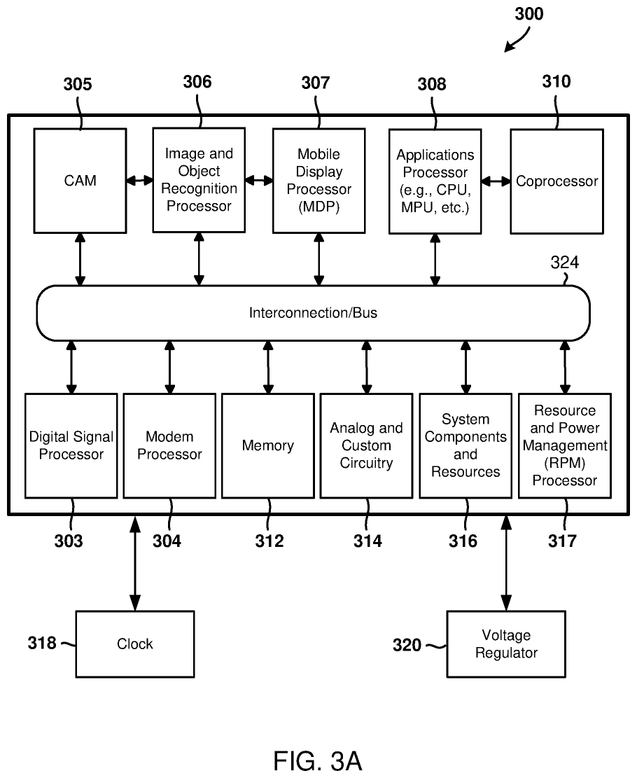

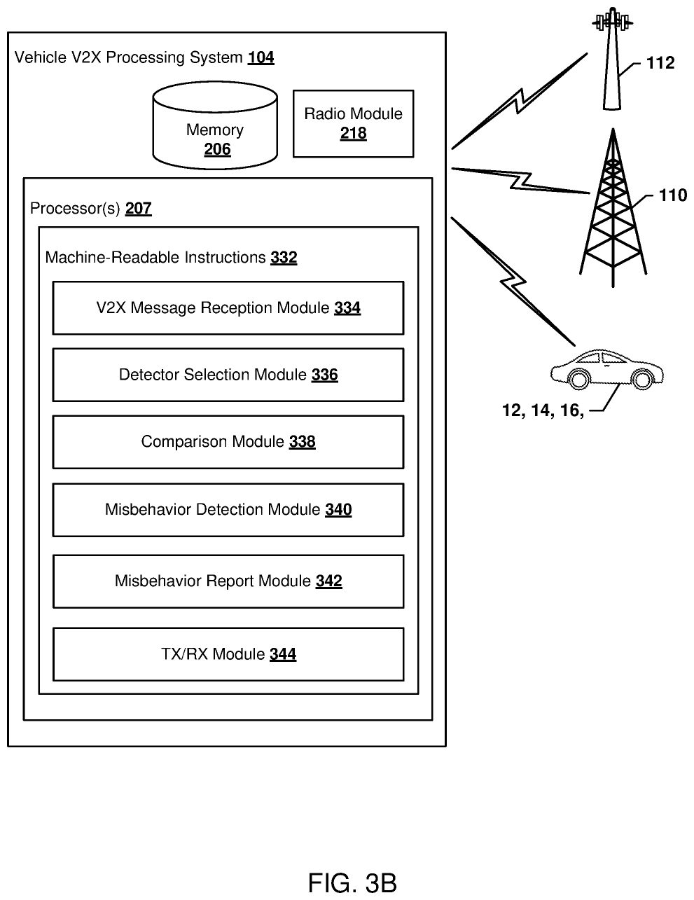

FIG. 3A is a block diagram illustrating an example components of a system on chip (SOC) 300 for use in a vehicle V2X processing system in accordance with various embodiments. With reference to FIGS. 1A-3A, the processing device SOC 300 may include a number of heterogeneous processors, such as a digital signal processor (DSP) 303, a modem processor 304, an image and object recognition processor 306, a mobile display processor 307, an applications processor 308, and a resource and power management (RPM) processor 317. The processing device SOC 300 may also include one or more coprocessors 310 (e.g., vector co-processor) connected to one or more of the heterogeneous processors 303, 304, 306, 307, 308, 317.

Each of the processors may include one or more cores, and an independent/internal clock. Each processor/core may perform operations independent of the other processors/cores. For example, the processing device SOC 300 may include a processor that executes a first type of operating system (e.g., FreeBSD, LINUX, OS X, etc.) and a processor that executes a second type of operating system (e.g., Microsoft Windows). In some embodiments, the applications processor 308 may be the SOC's 300 main processor, central processing unit (CPU), microprocessor unit (MPU), arithmetic logic unit (ALU), etc. The graphics processor 306 may be graphics processing unit (GPU).

The processing device SOC 300 may include analog circuitry and custom circuitry 314 for managing sensor data, analog-to-digital conversions, wireless data transmissions, and for performing other specialized operations, such as processing encoded audio and video signals for rendering in a web browser. The processing device SOC 300 may further include system components and resources 316, such as voltage regulators, oscillators, phase-locked loops, peripheral bridges, data controllers, memory controllers, system controllers, access ports, timers, and other similar components used to support the processors and software clients (e.g., a web browser) running on a computing device.

The processing device SOC 300 also include specialized circuitry for camera actuation and management (CAM) 305 that includes, provides, controls and/or manages the operations of one or more cameras (e.g., a primary camera, webcam, 3D camera, etc.), the video display data from camera firmware, image processing, video preprocessing, video front-end (VFE), in-line JPEG, high definition video codec, etc. The CAM 305 may be an independent processing unit and/or include an independent or internal clock.

In some embodiments, the image and object recognition processor 306 may be configured with processor-executable instructions and/or specialized hardware configured to perform image processing and object recognition analyses involved in various embodiments. For example, the image and object recognition processor 306 may be configured to perform the operations of processing images received from cameras via the CAM 305 to recognize and/or identify other vehicles, and otherwise perform functions of the camera perception layer 224 as described. In some embodiments, the processor 306 may be configured to process radar or lidar data and perform functions of the radar and/or lidar perception layer 222 as described.

The system components and resources 316, analog and custom circuitry 314, and/or CAM 305 may include circuitry to interface with peripheral devices, such as cameras, radar, lidar, electronic displays, wireless communication devices, external memory chips, etc. The processors 303, 304, 306, 307, 308 may be interconnected to one or more memory elements 312, system components and resources 316, analog and custom circuitry 314, CAM 305, and RPM processor 317 via an interconnection/bus module 324, which may include an array of reconfigurable logic gates and/or implement a bus architecture (e.g., CoreConnect, AMBA, etc.). Communications may be provided by advanced interconnects, such as high-performance networks-on chip (NoCs).

The processing device SOC 300 may further include an input/output module (not illustrated) for communicating with resources external to the SOC, such as a clock 318 and a voltage regulator 320. Resources external to the SOC (e.g., clock 318, voltage regulator 320) may be shared by two or more of the internal SOC processors/cores (e.g., a DSP 303, a modem processor 304, a graphics processor 306, an applications processor 308, etc.).

In some embodiments, the processing device SOC 300 may be included in a control unit (e.g., 140) for use in a vehicle (e.g., 100). The control unit may include communication links for communication with a telephone network (e.g., 180), the Internet, and/or a network server (e.g., 184) as described.

The processing device SOC 300 may also include additional hardware and/or software components that are suitable for collecting sensor data from sensors, including motion sensors (e.g., accelerometers and gyroscopes of an IMU), user interface elements (e.g., input buttons, touch screen display, etc.), microphone arrays, sensors for monitoring physical conditions (e.g., location, direction, motion, orientation, vibration, pressure, etc.), cameras, compasses, GPS receivers, communications circuitry (e.g., Bluetooth®, WLAN, WiFi, etc.), and other well-known components of modern electronic devices.

FIG. 3B is a component block diagram illustrating elements of a vehicle V2X processing system 104 configured in accordance with various embodiments. With reference to FIGS. 1A-3B, the V2X processing system 104 of a vehicle (e.g., 102) may be configured to communicate with a roadside unit 112, a cellular network base station 110, and/or one or more other vehicles 12, 14, 16.

The vehicle V2X processing system 104 may include one or more processors 205, memory 206, a radio module 218, and other components. The vehicle processing system 104 may include a plurality of hardware, software, and/or firmware components operating together to provide the functionality attributed herein to the processor 205.

The memory 206 may include non-transitory storage media that electronically stores information. The electronic storage media of memory 206 may include one or both of system storage that is provided integrally (i.e., substantially non-removable) with the vehicle processing system 104 and/or removable storage that is removably connectable to the vehicle V2X processing system 104 via, for example, a port (e.g., a universal serial bus (USB) port, a firewire port, etc.) or a drive (e.g., a disk drive, etc.). In various embodiments, memory 206 may include one or more of electrical charge-based storage media (e.g., EEPROM, RAM, etc.), solid-state storage media (e.g., flash drive, etc.), optically readable storage media (e.g., optical disks, etc.), magnetically readable storage media (e.g., magnetic tape, magnetic hard drive, floppy drive, etc.), and/or other electronically readable storage media.

The memory 206 may include one or more virtual storage resources (e.g., cloud storage, a virtual private network, and/or other virtual storage resources). Memory 206 may store software algorithms, information determined by processor(s) 205, information received from the one or more other vehicles 12, 14, 16, information received from the roadside unit 112, information received from the base station 110, and/or other information that enables the vehicle V2X processing system 104 to function as described herein.

The processor(s) 205 may include one of more local processors that may be configured to provide information processing capabilities in the vehicle V2X processing system 104. As such, the processor(s) 205 may include one or more of a digital processor, an analog processor, a digital circuit designed to process information, an analog circuit designed to process information, a state machine, and/or other mechanisms for electronically processing information. Although the processor(s) 205 is shown in FIG. 3B as a single entity, this is for illustrative purposes only. In some embodiments, the processor(s) 205 may include a plurality of processing units. These processing units may be physically located within the same device, or the processor(s) 205 may represent processing functionality of a plurality of devices distributed in the vehicle and operating in coordination.

The vehicle V2X processing system 104 may be configured by machine-readable instructions 332, which may include one or more instruction modules. The instruction modules may include computer program modules. In various embodiments, the instruction modules may include one or more of a V2X message reception module 334, a detector selection module 336, a comparison module 338, a misbehavior detection module 340, a misbehavior report module 342, a TX/RX module 344, and/or other modules.

The V2X message reception module 334 may be configured to receive a V2X message from another vehicle (e.g., 12, 14, 16).

The detector selection module 336 may be configured to select a first detector based on the first V2X message type and a second detector based on the second V2X message type. The detector selection module 336 may be configured to select one or more detectors based on a V2X message type in a received V2X message and/or in a V2X message stored in the memory 206. The detector selection module 336 may be configured to select a first field in the first V2X message and a second field in the second V2X message by identifying a field in the first V2X message and a field in the second V2X message that include analogous information.

The comparison module 338 may be configured to compare a first field in a first V2X message of a first V2X message type to a second field in a second V2X message of a second V2X message type. The first and second V2X message types may be different. The comparison module 338 may be configured to compare the first field in the first V2X message of the first V2X message type to the second field in the second V2X message of the second V2X message type using the selected (e.g., first and second) detectors. In some embodiments, the comparison module 330 may be configured to compare a result of applying the first detector to information in the first V2X message to a result of applying the second detector to information in the second V2X message. The comparison module 330 also may be configured to compare a time value and a location value associated with the first field in the first V2X message of the first V2X message type and the second field in the second V2X message.

The misbehavior detection module 340 may be configured to identify misbehavior in either the first V2X message or the second V2X message based on the comparison of the first V2X message and the second V2X message. The misbehavior detection module 340 may be configured to identify misbehavior in either the first or second V2X messages when information in the first field is inconsistent with information in the second field.

The misbehavior report module 342 may be configured to take an action in response to identifying misbehavior in the first V2X message or the second V2X message. The misbehavior report module 342 may be configured to generate a misbehavior report indicating the identified misbehavior. The misbehavior report module 342 also may be configured to generate a correction for information in the first field or the second field when one of the time and location values associated with the first field in the first V2X message of the first V2X message type and the second field in the second V2X message are not substantially the same.

The TX/RX module 344 may be configured to control the operations of communication devices of the vehicle processing system such as the radio module 218. The TX/RX module 344 may be configured to transmit a generated misbehavior report indicating the identified misbehavior to a network computing device, such as the Misbehavior Authority computing device 132.

The processor(s) 207 may be configured to execute the modules 332-344 and/or other modules by software, hardware, firmware, some combination of software, hardware, and/or firmware, and/or other mechanisms for configuring processing capabilities on processor(s) 205.

The description of the functionality provided by the different modules 332-344 is for illustrative purposes, and is not intended to be limiting, as any of modules 332-344 may provide more or less functionality than is described. For example, one or more of modules 332-344 may be eliminated, and some or all of its functionality may be provided by other ones of modules 332-344. As another example, processor(s) 207 may be configured to execute one or more additional modules that may perform some or all of the functionality attributed below to one of modules 332-344.

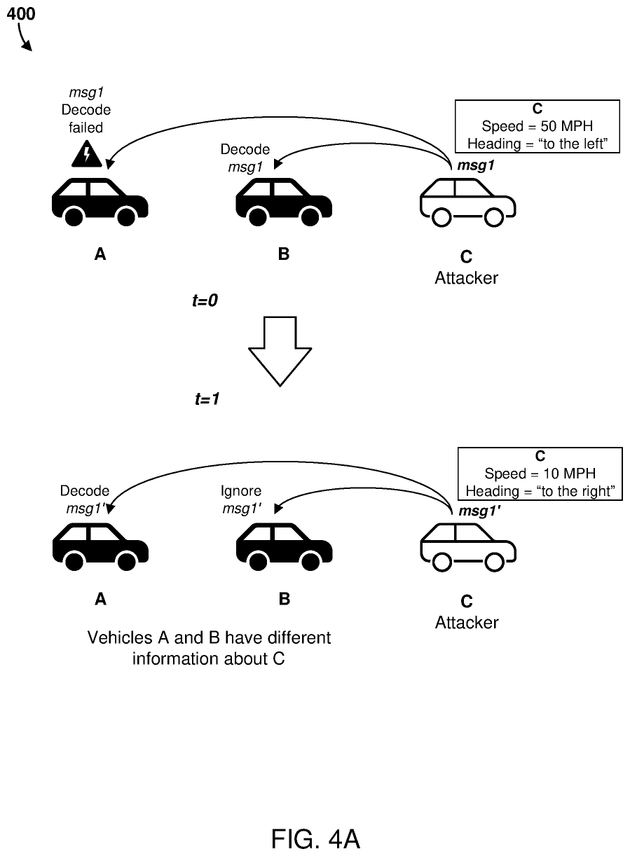

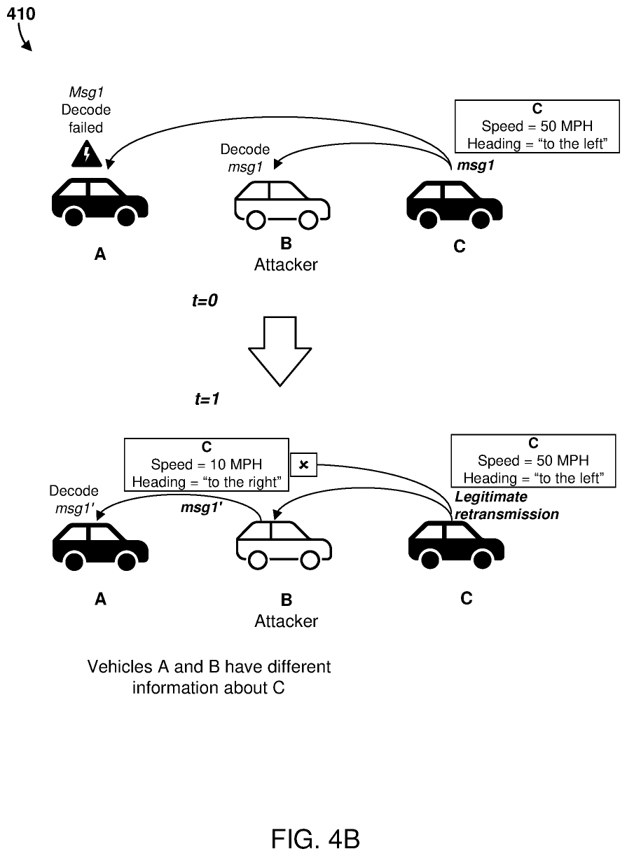

FIG. 4A is a conceptual diagram of an example of a first type of retransmission attack 400 in a message retransmission scenario. The illustrated retransmission attack 400 is an example of an attack that attempts to disseminate inconsistent information among various receiving devices.

With reference to FIGS. 1A-4A, at a first time t=0, an attacker C (a transmitter device) may transmit a first message (msg1) indicating, for example, that C's speed is “50 miles per hour” and that a maneuvering heading of C is “to the left.” A first receiving device (A) may fail to decode the first message msg1, and a second receiving device (B) may successfully decode the first message msg1. Although the first receiving device A fails to decode the first message msg1, the first receiving device A may retain an incomplete, garbled, or partially decoded version of the first message msg1.

At a second time t=1, the attacker C may transmit a second message (msg1′) that purports to be a retransmission of the first message, but actually is different from the first message (msg1′≠msg1). For example, the second message msg1′ may indicate that C's speed is “10 miles per hour” and that a maneuvering heading of C is “to the right.”

After the first receiving device A successfully decodes the second message msg1′, the first receiving device A and the second receiving device B have different information about C (e.g., different information about C's kinematic state). Some retransmission protocols, such as Incremental Redundancy HARQ, may permit the attacker C to transmit the second message msg1′ at a sufficiently high transmit power that causes the first receiving device A to successfully decode the second message msg1′ without reference to the first message msg1 or another message (e.g., a third message).

FIG. 4B is a conceptual diagram of an example of a second type of retransmission attack 410 in a message retransmission scenario. This retransmission attack 410 is an example of an attack that makes use of physical layer masquerading and/or jamming.

With reference to FIGS. 1A-4B, at a first time t=0, a legitimate transmitting device may transmit a first message (msg1) indicating, for example, that C's speed is “50 miles per hour” and that a maneuvering heading of C is “to the left.” A first receiving device (A) may fail to decode the first message msg1, and a second receiving device (B) may successfully decode the first message.

In this example of the second type of retransmission attack, the second receiving device B is also an attacker. At a second time t=1, the legitimate transmitting device C may transmit the legitimate retransmission of the first message msg1. However, at the same time, the attacker B may transmit a second message msg1′ that is an attack message that includes conflicting or incorrect information about the transmitting vehicle C (e.g., C's speed is “10 MPH” and C's heading is “to the right”).

In some attacks, the attacker B may transmit the second message msg1′ in a manner configured to jam the legitimate retransmission by transmitting device C, such as transmitting the second message msg1′ at a higher transmit power, encoding the second message msg1′ with the same or different decode parameters (such as RV or MCS), and the like. In some circumstances, depending on certain Transport Block parameters (e.g., packet size, MCS, code rate, and/or the like), the receiving device may be able to decode second message msg1′ without reference to the first message msg1 or another message (e.g., a third message).

To address retransmission attacks such as those illustrated in FIGS. 4A and 4B, various embodiments include methods that may be performed by a computing device for misbehavior detection in message retransmission events.

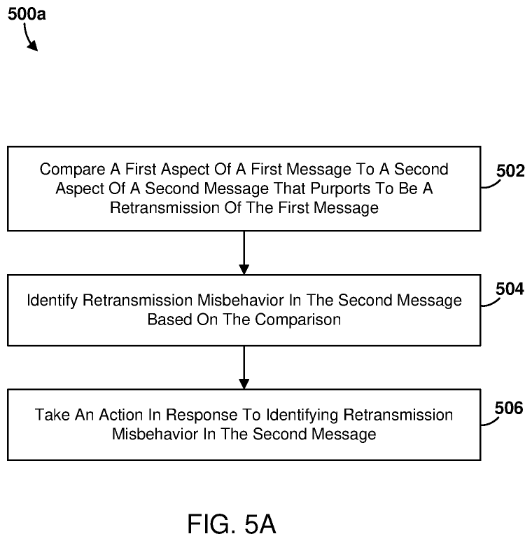

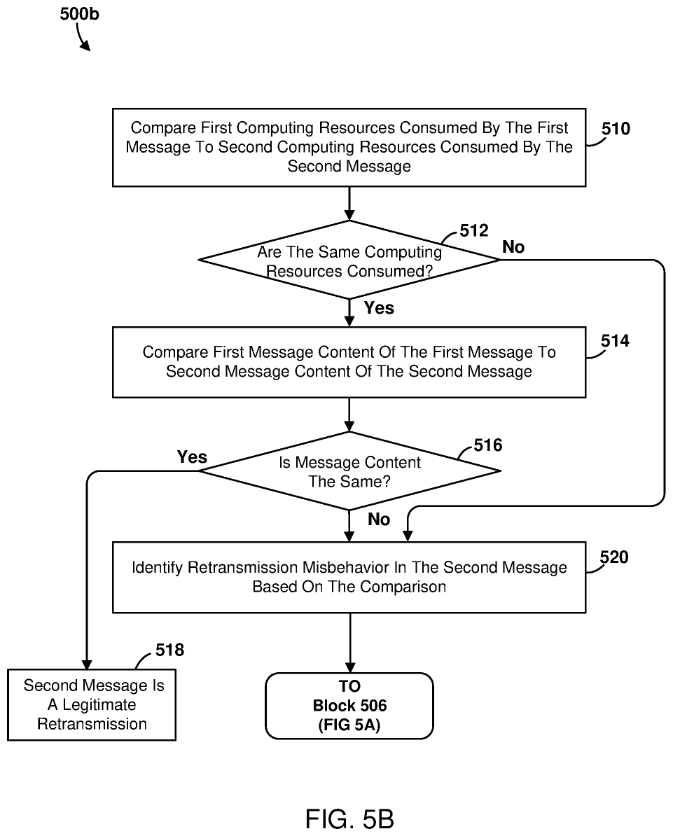

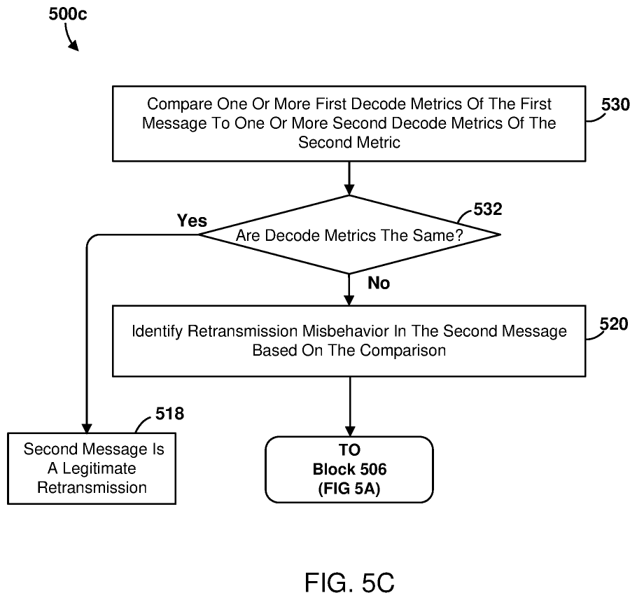

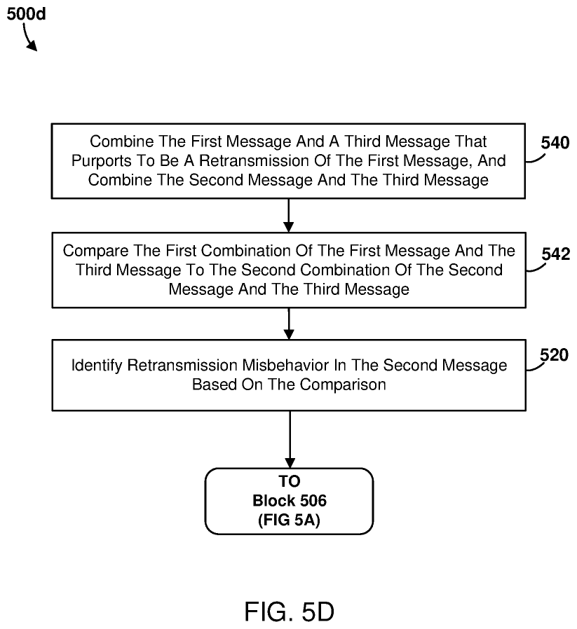

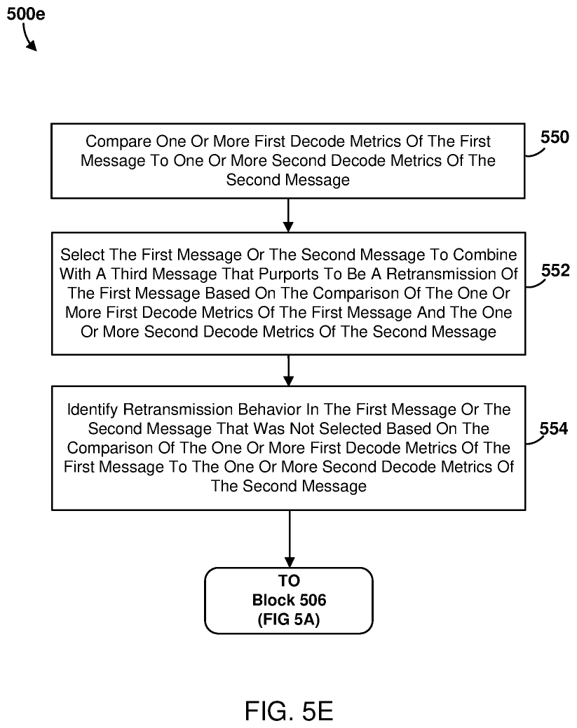

FIG. 5A is a process flow diagram of an example method 500a performed by a processor of computing device for misbehavior detection in a message retransmission. With reference to FIGS. 1A-5A, the method 500a may be performed by one or more processors (e.g., 205, 300) of a computing device that may be implemented in hardware elements, software elements, or a combination of hardware and software elements. Non-limiting examples of a computing device include a V2X processing system or other vehicle processor (e.g., 205, 220, 300), a processor of a roadside unit (e.g., 112), and a processor of an Edge computing device. To encompass any of the processors, hardware elements and software element that may be involved in performing the method 500, the element or subsystems performing method operations are referred to generally as a “processor.”

In block 502, the processor may compare a first aspect of a first message to a second aspect of a second message that purports to be a retransmission of the first message. For example, the processor of a receiving device A may compare some aspects of the first message, such as a partial, incomplete, corrupted, garbled, partially decoded, etc. of the first message (e.g., msg1), which were received and stored temporarily in memory, to similar aspects of the purported retransmission of the first message (i.e., the second message, e.g., msg1′) that has been received and decoded.

In block 504, the processor may identify retransmission misbehavior in the second message based on the comparison. For example, if the comparison of the aspects of the two messages reveals that the two messages are different, this conflict in the compared aspects may indicate that a retransmission attack is being attempted.

In block 506, the processor may take an action or actions in response to identifying retransmission misbehavior in the second message. In the context of V2X communications, such an action or actions may be performed to improve safety of the detecting vehicle, other vehicles that may have been affected by the attack, and/or the highway system. For example, the processor may transmit a misbehavior report to a Misbehavior Authority or another suitable network entity as part of the actions taken in block 506. As another example of actions that may be taken in block 506, the processor may transmit a misbehavior report to one or more nearby computing devices (e.g., another vehicle, a roadside unit, and/or the like) to notify other computing devices of the retransmission misbehavior. In some embodiments, as part of the actions taken in block 506 the processor may transmit a misbehavior report that includes information regarding the conflicting information or nature of the retransmission attack so that other computing devices (e.g., other vehicles) or the highway system can determine responsive actions to maintain system safety and/or security.

FIG. 5B is a process flow diagram of example operations 500b that may be performed by a processor of a computing device as part of the method 500a for misbehavior detection in a message retransmission. With reference to FIGS. 1A-5B, the operations 500b may be performed by one or more processors (e.g., 205, 300) of a computing device that may be implemented in hardware elements, software elements, or a combination of hardware and software elements. Non-limiting examples of a computing device include a V2X processing system or other vehicle processor (e.g., 205, 220, 300), a processor of a roadside unit (e.g., 112), and a processor of an Edge computing device.

In block 510, the processor may compare first computing resources consumed by the first message to second computing resources consumed by the second message. For example, the processor may determine processing burdens of receiving and/or attempting to decode the first message and the second message, such as the resources consumed, memory resources consumed, an amount of time consumed, and other suitable resources consumed in receiving and decoding the two messages. The processor may then compare the two determined resource burdens in block 510.

In determination block 512, the processor may determine whether the first computing resources consumed by the first message are the same as the second computing resources consumed by the second message.

In response to determining that the first computing resources consumed by the first message and the second computing resources consumed by the second message are the same (e.g., determination block 512=“Yes”), the processor may compare first message content of the first message to second message content of the second message in block 514.

In determination block 516, the processor may determine whether the first message content and the second message content are the same.

In response to determining that the first message content and the second message content are the same (i.e., determination block 516=“Yes”), the processor may determine that the second message is a legitimate retransmission of the first message in block 518.

In response to determining that the first computing resources consumed by the first message and the second computing resources consumed by the second message are not the same (e.g., determination block 512=“No”), or in response to determining that the first message content and the second message content are not the same (i.e., determination block 516=“No”), the processor may identify retransmission behavior in the second message in block 520, and take an action in block 506 of the method 500a as described.

FIG. 5C is a process flow diagram of example operations 500c that may be performed by a processor of a computing device as part of the method 500a for misbehavior detection in a message retransmission. With reference to FIGS. 1A-5C, the operations 500c may be performed by one or more processors (e.g., 205, 300) of a computing device that may be implemented in hardware elements, software elements, or a combination of hardware and software elements. Non-limiting examples of a computing device include a V2X processing system or other vehicle processor (e.g., 205, 220, 300), a processor of a roadside unit (e.g., 112), and a processor of an Edge computing device.

In block 530, the processor may compare one or more first decode metrics of the first message to one or more second decode metrics of the second metric. In some embodiments, the processor may compare one or more first decode metrics of the first message to one or more second decode metrics of the second metric.

In determination block 532, the processor may determine whether the first decode metrics and the second decode metrics are the same.

In response to determining that the first decode metrics and the second decode metrics are the same (i.e., determination block 532=“Yes”), the processor may determine that the second message is a legitimate retransmission of the first message in block 518.

In response to determining that the first decode metrics and the second decode metrics are not the same (i.e., determination block 532=“No”), the processor may identify retransmission misbehavior in the second message in block 520, and take an action in block 506 of the method 500a as described.

FIG. 5D is a process flow diagram of example operations 500d that may be performed by a processor of a computing device as part of the method 500a for misbehavior detection in a message retransmission. With reference to FIGS. 1A-5D, the operations 500d may be performed by one or more processors (e.g., 205, 300) of a computing device that may be implemented in hardware elements, software elements, or a combination of hardware and software elements. Non-limiting examples of a computing device include a V2X processing system or other vehicle processor (e.g., 205, 220, 300), a processor of a roadside unit (e.g., 112), and a processor of an Edge computing device.

In block 540, the processor may combine the first message and the third message that purports to be a retransmission of the first message, and may combine the second message and the third message. For example, the processor may store the first message and the second message separately and not combine the first message and the second message with each other.

In block 542, the processor may compare the first combination of the first message and the third message to the second combination of the second message and the third message. In some embodiments, the processor may attempt to decode the first combination and the second combination. In some embodiments, the processor may determine whether the decoding of the first combination or the second combination was successful. In some embodiments, the processor may compare the success of the decoding attempts of the first combination and the second combination. In some embodiments, the computing device may compare verification information of each of the two combinations, such as a CRC. For example, if the second message is an attack message, a CRC of the second combination may fail a verification check, while a CRC of the first combination may pass.

In block 520, the processor may identify retransmission misbehavior in the second message based on the comparison. For example, the processor may determine that the attempt to decode the first combination (of the first message and the third message) was successful, and the attempt to decode the second combination (of the second message and the third message) was not successful. The processor may identify retransmission misbehavior in the second message based on the unsuccessful decoding attempt on the second combination.

The processor may then take an action in block 506 of the method 500a as described.

FIG. 5E is a process flow diagram of example operations 500e that may be performed by a processor of a computing device as part of the method 500a for misbehavior detection in a message retransmission. With reference to FIGS. 1A-5E, the operations 500e may be performed by one or more processors (e.g., 205, 300) of a computing device that may be implemented in hardware elements, software elements, or a combination of hardware and software elements. Non-limiting examples of a computing device include a V2X processing system or other vehicle processor (e.g., 205, 220, 300), a processor of a roadside unit (e.g., 112), and a processor of an Edge computing device.

In block 550, the processor may compare one or more first decode metrics of the first message to one or more second decode metrics of the second message.

In block 552, the processor may select the first message or the second message to combine with a third message that purports to be a retransmission of the first message based on the comparison of the one or more first decode metrics of the first message to the one or more second decode metrics of the second message.

In block 554, the processor may identify retransmission behavior in the first message or the second message that was not selected based on the comparison of the one or more first decode metrics of the first message to the one or more second decode metrics of the second message.

The processor may take an action in block 506 of the method 500a as described.

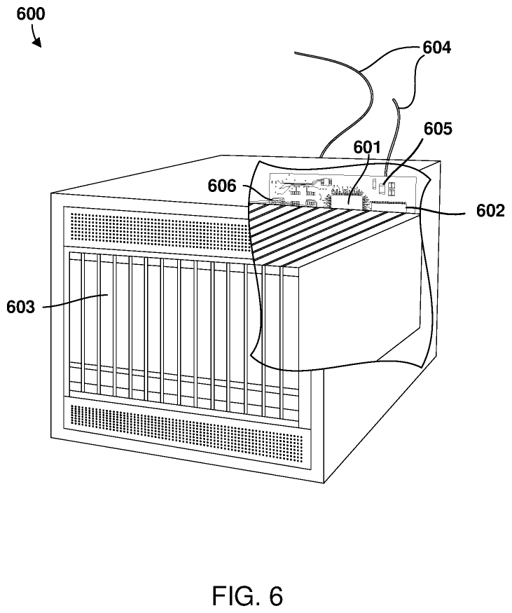

FIG. 6 is a component block diagram of a network computing device 600 suitable for use with various embodiments. With reference to FIGS. 1A-6, various embodiments (including, but not limited to, embodiments described with reference to FIGS. 1A-5E) may be implemented on a variety of computing devices, an example of which is illustrated in FIG. 6 in the form of a server device. A network computing device 600 may include a processor 601 coupled to volatile memory 602 and a large capacity nonvolatile memory, such as a disk drive 603. The network computing device 600 may also include a peripheral memory access device such as a floppy disc drive, compact disc (CD) or digital video disc (DVD) drive 606 coupled to the processor 601. The network computing device 600 may also include network access ports 604 (or interfaces) coupled to the processor 601 for establishing data connections with a network, such as the Internet and/or a local area network coupled to other system computers and servers. The network computing device 600 may include one or more transceivers 605 for sending and receiving electromagnetic radiation that may be connected to a wireless communication link. The network computing device 600 may include additional access ports, such as USB, Firewire, Thunderbolt, and the like for coupling to peripherals, external memory, or other devices.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the operations of the methods and operations 500a-500e may be substituted for or combined with one or more operations of the methods or operations 500a-500e.

Implementation examples are described in the following paragraphs. While some of the following implementation examples are described in terms of example methods, further example implementations may include: the example methods discussed in the following paragraphs implemented by a computing device including a processor configured with processor-executable instructions to perform operations of the methods of the following implementation examples; the example methods discussed in the following paragraphs implemented by a computing device including means for performing functions of the methods of the following implementation examples; and the example methods discussed in the following paragraphs may be implemented as a non-transitory processor-readable storage medium having stored thereon processor-executable instructions configured to cause a processor of a computing device to perform the operations of the methods of the following implementation examples.

Example 1. A method performed by a processor of a computing device, including comparing a first aspect of a first message to a second aspect of a second message that purports to be a retransmission of the first message, identifying retransmission misbehavior in the second message based on the comparison, and taking an action in response to identifying retransmission misbehavior in the second message.

Example 2. The method of example 1, in which comparing the first aspect of the first message and the second aspect of the second message includes comparing first computing resources consumed by the first message and second 2 computing resources consumed by the second message.

Example 3. The method of example 2, further including comparing first message content of the first message to second message content of the second message in response to determining that the computing resources consumed by the first message and the computing resources consumed by the second message are the same, in which identifying retransmission misbehavior in the second message based on the comparison includes identifying retransmission misbehavior in the second message in response to determining that the first message content of the first message and the second message content of the second message are not the same.

Example 4. The method of any of examples 1-3, in which comparing the first aspect of the first message and the second aspect of the second message includes comparing one or more first decode metrics of the first message to one or more second decode metrics of the second metric.

Example 5. The method of any of examples 1-4, in which comparing the first aspect of the first message to the second aspect of the second message includes comparing one or more first Layer 1 or Layer 2 decode metrics of the first message to one or more second Layer 1 or Layer 2 decode metrics of the second metric.

Example 6. The method of any of examples 1-5, in which comparing the first aspect of the first message and the second aspect of the second message includes comparing a first combination of the first message and a third message that purports to be a retransmission of the first message, to a second combination of the second message and the third message.

Example 7. The method of any of examples 1-6, in which comparing the first aspect of the first message and the second aspect of the second message includes comparing one or more first decode metrics of the first message to one or more second decode metrics of the second message, and selecting the first message or the second message to combine with a third message that purports to be a retransmission of the first message based on the comparison of the one or more first decode metrics of the first message to the one or more second decode metrics of the second message, in which identifying retransmission misbehavior in the second message based on the comparison includes identifying retransmission behavior in the first message or the second message that was not selected based on the comparison of the one or more first decode metrics of the first message to the one or more second decode metrics of the second message.

Example 8. The method of any of examples 1-7, in which the computing device includes a vehicle-to-everything (V2X) processing system.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof. If implemented in software, the functions may be stored as one or more instructions or code on a non-transitory computer-readable medium or non-transitory processor-readable medium. The operations of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. A method performed by a processor of a computing device, comprising:
comparing a first aspect of a first message to a second aspect of a second message that purports to be a retransmission of the first message;
identifying retransmission misbehavior in the second message based on the comparison; and
taking an action in response to identifying retransmission misbehavior in the second message.

2. The method of claim 1, wherein comparing the first aspect of the first message and the second aspect of the second message comprises comparing first computing resources consumed by the first message and second 2 computing resources consumed by the second message.

3. The method of claim 2, further comprising:
comparing first message content of the first message to second message content of the second message in response to determining that the computing resources consumed by the first message and the computing resources consumed by the second message are the same,
wherein identifying retransmission misbehavior in the second message based on the comparison comprises identifying retransmission misbehavior in the second message in response to determining that the first message content of the first message and the second message content of the second message are not the same.

4. The method of claim 1, wherein comparing the first aspect of the first message and the second aspect of the second message comprises comparing one or more first decode metrics of the first message to one or more second decode metrics of the second metric.

5. The method of claim 1, wherein comparing the first aspect of the first message to the second aspect of the second message comprises comparing one or more first Layer 1 or Layer 2 decode metrics of the first message to one or more second Layer 1 or Layer 2 decode metrics of the second metric.

6. The method of claim 1, wherein comparing the first aspect of the first message and the second aspect of the second message comprises comparing a first combination of the first message and a third message that purports to be a retransmission of the first message, to a second combination of the second message and the third message.

7. The method of claim 1, wherein comparing the first aspect of the first message and the second aspect of the second message comprises:
comparing one or more first decode metrics of the first message to one or more second decode metrics of the second message; and
selecting the first message or the second message to combine with a third message that purports to be a retransmission of the first message based on the comparison of the one or more first decode metrics of the first message to the one or more second decode metrics of the second message,
wherein identifying retransmission misbehavior in the second message based on the comparison comprises identifying retransmission behavior in the first message or the second message that was not selected based on the comparison of the one or more first decode metrics of the first message to the one or more second decode metrics of the second message.

8. The method of claim 1, wherein the computing device comprises a vehicle-to-everything (V2X) processing system.

9. A computing device, comprising:
a transceiver; and
a processor coupled to the transceiver and configured to:
compare a first aspect of a first message to a second aspect of a second message that purports to be a retransmission of the first message;
identify retransmission misbehavior in the second message based on the comparison; and
take an action in response to identifying retransmission misbehavior in the second message.

10. The computing device of claim 9, wherein the processor is further configured to compare first computing resources consumed by the first message and second 2 computing resources consumed by the second message.

11. The computing device of claim 10, wherein the processor is further configured to:
compare first message content of the first message to second message content of the second message in response to determining that the computing resources consumed by the first message and the computing resources consumed by the second message are the same; and
identify retransmission misbehavior in the second message in response to determining that the first message content of the first message and the second message content of the second message are not the same.

12. The computing device of claim 9, wherein the processor is further configured to compare one or more first decode metrics of the first message to one or more second decode metrics of the second metric.

13. The computing device of claim 9, wherein the processor is further configured to compare one or more first Layer 1 or Layer 2 decode metrics of the first message to one or more second Layer 1 or Layer 2 decode metrics of the second metric.

14. The computing device of claim 9, wherein the processor is further configured to compare a first combination of the first message and a third message that purports to be a retransmission of the first message, to a second combination of the second message and the third message.

15. The computing device of claim 9, wherein the processor is further configured to:
compare one or more first decode metrics of the first message to one or more second decode metrics of the second message;
select the first message or the second message to combine with a third message that purports to be a retransmission of the first message based on the comparison of the one or more first decode metrics of the first message to the one or more second decode metrics of the second message; and
identify retransmission behavior in the first message or the second message that was not selected based on the comparison of the one or more first decode metrics of the first message to the one or more second decode metrics of the second message.

16. The computing device of claim 9, wherein the computing device comprises a vehicle-to-everything (V2X) processing system.

17. A computing device, comprising:
means for comparing a first aspect of a first message to a second aspect of a second message that purports to be a retransmission of the first message;
means for identifying retransmission misbehavior in the second message based on the comparison; and
means for taking an action in response to identifying retransmission misbehavior in the second message.

18. The computing device of claim 17, wherein means for comparing the first aspect of the first message and the second aspect of the second message comprises means for comparing first computing resources consumed by the first message and second 2 computing resources consumed by the second message.

19. The computing device of claim 18, further comprising:
means for comparing first message content of the first message to second message content of the second message in response to determining that the computing resources consumed by the first message and the computing resources consumed by the second message are the same,
wherein means for identifying retransmission misbehavior in the second message based on the comparison comprises means for identifying retransmission misbehavior in the second message in response to determining that the first message content of the first message and the second message content of the second message are not the same.

20. The computing device of claim 17, wherein means for comparing the first aspect of the first message and the second aspect of the second message comprises means for comparing one or more first decode metrics of the first message to one or more second decode metrics of the second metric.

21. The computing device of claim 17, wherein means for comparing the first aspect of the first message to the second aspect of the second message comprises means for comparing one or more first Layer 1 or Layer 2 decode metrics of the first message to one or more second Layer 1 or Layer 2 decode metrics of the second metric.

22. The computing device of claim 17, wherein means for comparing the first aspect of the first message and the second aspect of the second message comprises means for comparing a first combination of the first message and a third message that purports to be a retransmission of the first message, to a second combination of the second message and the third message.

23. The computing device of claim 17, wherein means for comparing the first aspect of the first message and the second aspect of the second message comprises:
means for comparing one or more first decode metrics of the first message to one or more second decode metrics of the second message; and
means for selecting the first message or the second message to combine with a third message that purports to be a retransmission of the first message based on the comparison of the one or more first decode metrics of the first message to the one or more second decode metrics of the second message,
wherein means for identifying retransmission misbehavior in the second message based on the comparison comprises means for identifying retransmission behavior in the first message or the second message that was not selected based on the comparison of the one or more first decode metrics of the first message to the one or more second decode metrics of the second message.

24. The computing device of claim 17, wherein the computing device comprises a vehicle-to-everything (V2X) processing system.

25. A non-transitory processor-readable medium having stored thereon processor-executable instructions configured to cause a processing device of a computing device to perform operations comprising:
comparing a first aspect of a first message to a second aspect of a second message that purports to be a retransmission of the first message;
identifying retransmission misbehavior in the second message based on the comparison; and
taking an action in response to identifying retransmission misbehavior in the second message.

26. The non-transitory processor-readable medium of claim 25, wherein the stored processor-executable instructions are further configured to cause the processing device of the computing device to perform operations such that comparing the first aspect of the first message and the second aspect of the second message comprises comparing first computing resources consumed by the first message and second 2 computing resources consumed by the second message.

27. The non-transitory processor-readable medium of claim 26, wherein the stored processor-executable instructions are further configured to cause the processing device of the computing device to perform operations comprising:
comparing first message content of the first message to second message content of the second message in response to determining that the computing resources consumed by the first message and the computing resources consumed by the second message are the same,
wherein identifying retransmission misbehavior in the second message based on the comparison comprises identifying retransmission misbehavior in the second message in response to determining that the first message content of the first message and the second message content of the second message are not the same.

28. The non-transitory processor-readable medium of claim 25, wherein the stored processor-executable instructions are further configured to cause the processing device of the computing device to perform operations such that comparing the first aspect of the first message and the second aspect of the second message comprises comparing one or more first decode metrics of the first message to one or more second decode metrics of the second metric.

29. The non-transitory processor-readable medium of claim 25, wherein the stored processor-executable instructions are further configured to cause the processing device of the computing device to perform operations such that comparing the first aspect of the first message to the second aspect of the second message comprises comparing one or more first Layer 1 or Layer 2 decode metrics of the first message to one or more second Layer 1 or Layer 2 decode metrics of the second metric.

30. The non-transitory processor-readable medium of claim 25, wherein the stored processor-executable instructions are further configured to cause the processing device of the computing device to perform operations such that comparing the first aspect of the first message and the second aspect of the second message comprises comparing a first combination of the first message and a third message that purports to be a retransmission of the first message, to a second combination of the second message and the third message.
